(19) United States
(12) Patent Application Publication
(10) Pub. No.: US 2023/0053665 A1
(43) Pub. Date: Feb. 23, 2023

(54) SEALING TAPE BONDING WEAKLY OR NOT AT ALL ON ONE SIDE

(71) Applicant: TESA SE, Norderstedt (DE)

(72) Inventors: Li WANG, Hamburg (DE); Deniz Nixk AKIN, Hamburg (DE); Kim ELSENBACH, Bargteheide (DE); Hannes DAG, Hamburg (DE)

(73) Assignee: TESA SE, Norderstedt (DE)

(21) Appl. No.: 17/792,958

(22) PCT Filed: Jan. 15, 2021
(86) PCT No.: PCT/EP2021/050796

§ 371 Date: Jul. 14, 2022

(30) Foreign Application Priority Data
Jan. 15, 2020 (DE) 10 2020 200 452.8

(51) Int. Cl. C09J 7/26; C09J 7/38

(52) U.S. Cl. CPC C09J 7/26; C09J 7/385; C09J 2301/208; C09J 2301/302; C09J 2400/243; C09J 2433/006

(57) ABSTRACT

The invention relates to a sealing element with high sealing effect against air and moisture, which is easy to apply, and which moreover offers the possibility to reopen the sealed gap in an uncomplicated manner. Said solution is provided by an adhesive tape with differing adhesive power on the two main sides, which comprises a) a polymer foam layer and b) an outer adhesive compound layer and/or an outer thermoplastic film on one side of the polymer foam layer and is characterized in that, where the adhesive tape comprises an outer adhesive compound layer, the tape has a greater adhesive power on the side provided with the outer adhesive compound layer than on the opposing side and/or, where the adhesive tape comprises an outer thermoplastic film, the tape has a lower adhesive power on the side provided with the outer thermoplastic film than on the opposing side. The invention furthermore relates to the use of an adhesive tape according to the invention for sealing a joint between two components.

The invention relates to the technical field of adhesive tapes, of the kind used domestically and in industry commonly to join two substrates, but also for other purposes such as, for example, to protect surfaces or for sealing. Proposed more specifically is a foam adhesive tape which is suitable for sealing and which on its two main sides has different peel adhesion forces or is adhesively equipped only on one of its two main sides.

There are numerous constructions in different fields of industry, such as in construction and in vehicle building, for example, where seals are required. The sealing elements used for this purpose are often intended to seal gaps, of the kind resulting almost unavoidably when two components are joined, against the penetration of moisture and air, in order to preserve parts located behind them from damage caused as a result, such as from corrosion, for example. Mechanical joins, of the kind effectuated by screws, for example, are generally not in a position to bring about adequate sealing.

Frequently, therefore, silicone sealants, for example, are used in order to achieve appropriate sealing of the joins produced. Such sealants are very reliable in their processing, but do require a certain time to cure and therefore frequently cause process-related difficulties. The situation with other structural adhesives/sealants is similar, such as those based on epoxides or polyurethanes, for example.

Silicone foams as well are employed as sealants, being distinguished by good flame retardant properties and by their capacity for re-use. It is, however, difficult to process them in an automated operation, and they are also comparatively expensive.

Butyl sealants are established and inexpensive, but on the other hand are difficult to control in their metering and lack aging resistance. At relatively high pressures, moreover, they are frequently squeezed out of the gap.

Elastic sealants such as rubbers or styrene-butadiene rubbers afford established sealing properties and are also highly temperature-stable. Because they are not self-adhesive, however, they are fairly difficult to work with; moreover, they are inflexible, and the respective sealing element must therefore be an exact fit with the gap that is to be sealed.

Polyurethane foams exhibit good compression characteristics and can be processed in automated operations; moreover, foam-in-place applications are possible. Fluctuations in the dimensions of the foam in question are disadvantageous, and these substances are also susceptible to corrosion and breakdown under the influence of certain cleaning products.

A similar profile of the properties is displayed by EPDM foams; with these as well, owing to their irregular surface architecture, the sealing effect achievable is only limited.

WO 2009/086056 A2, conversely, describes a flashing tape which is intended to bring about exclusion moisture in construction applications. The construction disclosed for the tape encompasses a viscoelastic core layer and at least one elastomeric outer layer; furthermore, a pressure-sensitive adhesive layer may be included in order to adhere the tape to a substrate.

There is an ongoing need for systems with good applications qualities on the sealing of joins between two components. It was an object of the invention, therefore, to provide an easy-to-apply sealing element with high sealing effect with respect to air and moisture, which also offers the possibility of uncomplicated reopening of the sealed gap.

A first and general subject of the invention, which achieves this object, is an adhesive with differing peel adhesion on both main sides, which comprises
a) a polymer foam layer and
b) an outer pressure-sensitive adhesive layer and/or an outer thermoplastic film on respectively one side of the polymer foam layer;
   and which is characterized in that
   if the adhesive tape comprises an outer pressure-sensitive adhesive layer, it has a higher peel adhesion on its side equipped with the outer pressure-sensitive adhesive layer than on the opposite side and/or
   if the adhesive tape comprises an outer thermoplastic film, it has a lower peel adhesion on its side equipped with the outer thermoplastic film than on the opposite side.

As has emerged, an adhesive tape of this kind may be used advantageously for sealing joins between components, and on the one hand permits simple, reliable and precise application and on the other hand permits easy disassembly of the join. Moreover, it lends itself well to automated processing and exhibits controlled compression characteristics.

The general expression “adhesive tape” in the sense of this invention encompasses all sheetlike structures equipped self-adhesively on one or both sides, such as films or film sections extended in two dimensions, tapes with extended length and limited width, tape sections, labels, diecuts and the like, and also corresponding multilayer arrangements.

Adhesive tapes, or their adhesives, are frequently lined or protected with what is called a release liner, which is removed before the adhesive tape is applied. A release liner is not part of the adhesive tape, but merely a means for its production and/or storage.

Adhesive tapes are typically made available
in fixed lengths, such as tape by the meter, for example, or
as a continuous product in the form of rolls (Archimedean spiral) or coils wound onto a core.

Polymer Foam Layer

The adhesive tape of the invention comprises a polymer foam layer. A “polymer foam layer” or a “polymer foam” refers to a material having open and/or closed cells distributed over its entire mass and having an apparent density lower than that of the polymeric framework material. The expression “foam” means in particular that the layer in question comprises structures composed of gas-filled, frequently spherical or polyhedral cells which are bounded by liquid, semiliquid, relatively high-viscosity or solid cell struts or by an endogenous shell material and which are present in the layer in question in a proportion such that the density of the foamed layer is reduced in relation to the density of the matrix material—that is, the entirety of the nongaseous materials apart from any endogenous shell material present in the foam cells.

The framework material, also referred to below as polymer foam matrix, foam matrix, matrix or matrix material, in accordance with the invention comprises one or more polymers, which may have been blended with adjuvants. “Open cells” are voids within the foam but are not completely surrounded by framework material or endogenous shell material. “Closed cells” are voids which are completely surrounded by framework material or by endogenous shell material. The polymer foam layer of the adhesive tape of the invention is preferably a closed-cell foam.

With general preference, the polymer foam layer, more particularly the matrix material of the polymer foam layer, comprises to an extent of at least 35 wt %, more preferably at least 50 wt % and very preferably at least 70 wt %, more particularly at least 80 wt %, as for example at least 90 wt %, based in each case on the total weight of the polymer foam layer or total weight of the matrix material, respectively, one or more polymers. This polymer content may vary according to the nature of the base polymer. Possible polymers of the polymer foam layer include polyolefins, examples being polyethylenes such as high density polyethylene (HDPE), low density polyethylene (LDPE), linear low density polyethylene (LLDPE) and linear ultralow density polyethylene, polypropylene, and polybutylene; vinyl copolymers, examples being polyvinyl chloride and polyvinyl acetate; olefinically random or block copolymers, examples being ethylene-methyl acrylate copolymers, ethylene-vinyl acetate copolymers and ethylene-propylene copolymers and also ethylene-propylene-diene terpolymers (EPDM), and also polyalkylenes produced from monomer mixtures which comprise 1) a first alkene selected from ethylene, propylene or a mixture thereof, and 2) a second alkene selected from 1,2-alkenes having 4 to 8 carbon atoms such as 1,2-butene, 1,2-hexene or 1,2-octene; acrylonitrile-butadiene-styrene copolymers; acrylic polymers and copolymers; polycarbonates; polyimides; polyurethanes, examples being thermoplastic polyurethanes, more particularly polyester-based thermoplastic polyurethanes; polyesters, e.g., polyethylene terephthalate; and also combinations and blends of the aforesaid polymers. Illustrative blends include polypropylene-polyethylene blends, PVC-nitrile rubber blends, polyurethane-polyolefin blends, polyurethane-polycarbonate blends, and polyurethane-polyester blends. Blends of thermoplastic polymers, elastomeric polymers, and combinations thereof may also be included. Further possible blends comprise styrene-butadiene copolymers, polychloroprenes, e.g. neoprene, nitrile rubbers, butyl rubbers, polysulfide rubbers, cis-1,4-polyisoprene, ethylene-propylene terpolymers, e.g., EPDM rubber, silicone rubbers, silicone-polyurea block copolymers, polyurethane rubbers, natural rubbers, acrylate rubbers, thermoplastic rubbers, e.g., styrene-butadiene block copolymers, styrene-isoprene-styrene block copolymers, styrene-ethylene/butylene-styrene block copolymers, styrene-ethylene/propylene-styrene block copolymers, thermoplastic polyolefin rubbers, and combinations thereof.

The polymer or polymers of the polymer foam layer, more particularly of the matrix material of the polymer foam layer, are preferably selected from the group consisting of polyolefins; polyurethanes; polyvinyl chloride (PVC); blends of PVC and nitrile rubber; terpolymers of ethylene, propylene and a nonconjugated diene (EPDM); copolymers of ethylene and ethylene substituted by a polar group; blends of polyethylene and a polymer of an ethylene substituted by a polar group; poly(meth)acrylates; blends of poly(meth)acrylate and synthetic rubber, and also mixtures of two or more of the aforesaid polymers. The polymer foam layer, more particularly the matrix material of the polymer foam layer, therefore preferably contains at least 35 wt %, more preferably at least 50 wt % and very preferably at least 70 wt %, more particularly at least 80 wt %, as for example at least 90 wt %, based in each case on the total weight of the polymer foam layer or total weight of the matrix material, of one or more polymers selected from the group consisting of polyolefins; polyurethanes; polyvinyl chloride (PVC); blends of PVC and rubber; terpolymers of ethylene, propylene and a nonconjugated diene (EPDM); copolymers of ethylene and an ethylene substituted by a polar group; blends of polyethylene and a polymer of an ethylene substituted by a polar group; poly(meth)acrylates; blends of poly(meth)acrylate and synthetic rubber, and mixtures of two or more of the aforesaid polymers. With particular preference the matrix material of the polymer foam layer contains no polymers other than one or more polymers selected from the group consisting of polyolefins; polyurethanes; polyvinyl chloride (PVC); blends of PVC and rubber; terpolymers of ethylene, propylene and a nonconjugated diene (EPDM); copolymers of ethylene and an ethylene substituted by a polar group; blends of polyethylene and a polymer of an ethylene substituted by a polar group; poly(meth)acrylates; blends of poly(meth)acrylate and synthetic rubber, and mixtures of two or more of the aforesaid polymers.

A “polyolefin” refers to a polymer of the general structure —[CH₂—CR₁R₂-]n-, in which R₁ and R₂ independently of one another denote a hydrogen atom or a linear or branched, saturated aliphatic or cycloaliphatic group. The polyolefin is preferably polyethylene, polypropylene, polybutylene or a mixture of these. The polyethylene here may comprise one or more of the conventional polyethylene types such as HDPE, LDPE, LLDPE, VLDPE, VLLDPE, MDPE (medium-density PE), metallocene PE types such as mLLDPE and mHDPE, blends of these polyethylene types, and mixtures thereof. The polypropylene is preferably a crystalline polypropylene, more preferably a homopolypropylene (hPP). In one specific embodiment I of the polymer foam layer the matrix material of the polymer foam layer contains no polymers other than one or more polyolefins.

A copolymer of ethylene and an ethylene substituted by a polar group refers to a polymer of the general structure —[CH₂—CR₃R₄-]n-, in which R₃ or R₄ denotes a hydrogen atom and the remaining substitute in each case denotes a group containing at least one oxygen atom. The copolymer of ethylene and an ethylene substituted by a polar group is preferably an ethylene-vinyl acetate copolymer (EVA), an ethylene-methyl acrylate copolymer (EMA), an ethylene-acrylate copolymer (EEA), an ethylene-acrylic acid copolymer (EAA), an ethylene-butyl acrylate copolymer (EBA), or a mixture of these. The EVA preferably has a vinyl acetate content of 1 to 70 wt %, more preferably of 3 to 30 wt %, more particularly of 5 to 20 wt %. In one more specific variant of embodiment I of the polymer foam layer, the matrix material of the polymer foam layer contains no polymers other than one or more copolymers of ethylene and an ethylene substituted by a polar group. More particularly in this case the copolymer of ethylene and an ethylene substituted by a polar group is an ethylene-vinyl acetate copolymer (EVA). With particular preference in this embodiment, therefore, the matrix material of the polymer foam layer contains at least one ethylene-vinyl acetate copolymer (EVA). More particularly, the fraction of the entirety of all ethylene-vinyl acetate copolymers in the matrix material of the polymer foam layer is at least 50 wt %, more preferably at least 70 wt % and very preferably at least 80 wt %, more particularly at least 85 wt %, as for example at least 90 wt %, based in each case on the total weight of the matrix material. With very particular preference the matrix material contains no polymers other than one or more ethylene-vinyl acetate copolymers (EVA).

The matrix material of the polymer foam layer is preferably crosslinked. The crosslinking takes place preferably before the foaming of the matrix material. Matrix materials which comprise polymers selected from polyolefins and copolymers of ethylene and an ethylene substituted by a polar group are crosslinked preferably with electron beams. Also suitable are chemical crosslinking methods, such as crosslinking via grafted-on silane radicals with hydrolysable groups, which are then able to react with one another under the influence of moisture and catalysis; additionally, crosslinking via added silanes which contain a radically polymerizable double bond and are able to react with radicals formed in the polymer chains; and also crosslinking via added peroxides, which likewise react with radicals.

In an embodiment II of the polymer foam layer, the polymer foam layer, more particularly the matrix material of the polymer foam layer, comprises at least one poly(meth)acrylate. A “poly(meth)acrylate” is a polymer which is obtainable by a radical polymerization of acrylic and/or methacrylic monomers and also, optionally, further, copolymerizable monomers. More particularly a “poly(meth)acrylate” is a polymer whose monomer basis consists to an extent of at least 50 wt % of acrylic acid, methacrylic acid, acrylic esters and/or methacrylic esters, with acrylic esters and/or methacrylic esters being included at least proportionally, preferably to an extent of at least 30 wt %, based on the overall monomer basis of the polymer in question.

The polymer foam layer preferably comprises poly(meth)acrylates at in total 40 to 99.9 wt %, more preferably at in total 60 to 98 wt %, more particularly at in total 75 to 95 wt %, as for example at in total 80 to 90 wt %, based in case on the total weight of the polymer foam layer. One (single) poly(meth)acrylate or two or more poly(meth)acrylates may be present; therefore, in the continuation of the present description as well, the plural expression “poly(meth)acrylates”, and also the expression “in total”, includes in its meaning both the presence of one single poly(meth)acrylate and the presence of two or more poly(meth)acrylates.

The glass transition temperature of the poly(meth)acrylates is preferably <0° C., more preferably between −20 and −50° C. The glass transition temperature of polymers or of polymer blocks in block copolymers is determined in accordance with the invention by means of dynamic scanning calorimetry (DSC). For this purpose around 5 mg of an untreated polymer sample are weighed out into an aluminum crucible (volume 25 μl) and closed with a perforated lid. Measurement takes place using a DSC 204 F1 from Netzsch. Operation takes place under nitrogen for inertization. The sample is initially cooled to −150° C., then heated to +150° C. with a heating rate of 10 K/min, and again cooled to −150° C. The subsequent second heating curve is run again at 10 K/min and the change in the heat capacity is recorded. Glass transitions are recognized as steps in the thermogram.

The poly(meth)acrylate preferably comprises at least one proportionally copolymerized functional monomer which with particular preference is a monomer reactive with epoxide groups to form a covalent bond. Very preferably the proportionally copolymerized functional monomer which with particular preference is reactive with epoxide groups to form a covalent bond contains at least one functional group selected from the group consisting of carboxylic acid groups, sulfonic acid groups, phosphonic acid groups, hydroxyl groups, acid anhydride groups, epoxide groups and amino groups; more particularly it contains at least one carboxylic acid group. Very preferably the poly(meth)acrylate contains proportionally copolymerized acrylic acid and/or methacrylic acid. All of the stated groups exhibit reactivity with epoxide groups, so making the poly(meth)acrylate amenable advantageously to thermal crosslinking with introduced epoxides.

The poly(meth)acrylate may originate preferably from the following monomer composition:
a) at least one acrylic ester and/or methacrylic ester of the following formula (1)

CH₂═C(R^{I})(COOR^{II}) (1),
in which R^{I} is H or CH₃ and R^{II} is an alkyl radical having 4 to 18 carbon atoms;
b) at least one olefinically unsaturated monomer having at least one functional group selected from the group consisting of carboxylic acid groups, sulfonic acid groups, phosphonic acid groups, hydroxyl groups, acid anhydride groups, epoxide groups and amino groups;
c) optionally further acrylic esters and/or methacrylic esters and/or olefinically unsaturated monomers, which are copolymerizable with component (a).

It is particularly advantageous to choose the monomers of component a) with a fraction of 45 to 99 wt %, the monomers of component b) with a fraction of 1 to 15 wt % and the monomers of component c) with the fraction of 0 to 40 wt %, the figures being based on the monomer mixture for the base polymer without additions of possible additives such as resins etc.

With particular preference the poly(meth)acrylate may originate from the following monomer composition:

65 to 99 wt % of 2-ethylhexyl acrylate and/or n-butyl acrylate,

0 to 30 wt % of methyl acrylate,

1 to 15 wt % of acrylic acid.

The poly(meth)acrylate or poly(meth)acrylates are prepared preferably by conventional radical polymerizations or controlled radical polymerizations. The poly(meth)acrylates may be prepared by copolymerization of the monomers using customary polymerization initiators and also, optionally, chain transfer agents, with polymerization taking place at the customary temperatures in bulk, in emulsion, for example in water or liquid hydrocarbons, or in solution.

The poly(meth)acrylates are prepared preferably by copolymerization of the monomers in solvents, more preferably in solvents having a boiling range of 50 to 150° C., more particularly of 60 to 120° C., using 0.01 to 5 wt %, more particularly 0.1 to 2 wt %, of polymerization initiators, based in each case on the total weight of the monomers.

All customary initiators are suitable in principle. Examples of radical sources are peroxides, hydroperoxides and azo compounds, examples being dibenzoyl peroxide, cumene hydroperoxide, cyclohexanone peroxide, di-tert-butyl peroxide, cyclohexylsulfonyl acetyl peroxide, diisopropyl percarbonate, tert-butyl peroctoate and benzopinacol. Preferred radical initiators are 2,2′-azobis(2-methylbutyronitrile) (Vazo® 67™ from DuPont) or 2,2′-azobis(2-methylpropionitrile) (2,2′-azobisisobutyronitrile; AIBN; Vazo® 64™ from DuPont).

Preferred solvents for the preparation of the poly(meth)acrylates are alcohols such as methanol, ethanol, n- and isopropanol, n- and isobutanol, more particularly isopropanol and/or isobutanol; hydrocarbons such as toluene and more particularly mineral spirits with a boiling range of 60 to 120° C.; ketones, more particularly acetone, methyl ethyl ketone, methyl isobutyl ketone; esters such as ethyl acetate, and mixtures of the aforesaid solvents. Particularly preferred solvents are mixtures which contain isopropanol in amounts of 2 to 15 wt %, more particularly of 3 to 10 wt %, based in each case on the solvent mixture employed.

The preparation (polymerization) of the poly(meth)acrylates is preferably followed by concentration, and the further processing of the poly(meth)acrylates is substantially solvent-free. The concentration of the polymer may take place in the absence of crosslinker and accelerator substances. An alternative option is to add one of these classes of compound to the polymer even prior to the concentration, so that the concentration then takes place in the presence of this or these substances.

After the concentration step, the polymers may be transferred to a compounder. An optional possibility is for concentration and compounding to take place in the same reactor, as well. The further processing after the concentration (compounding) takes place preferably in one or more extruders. In that case the composition is applied from the melt to a possibly temporary carrier material and is shaped to a layer by means of calander rolls.

The weight-average molecular weights M_{w} of the poly(meth)acrylates are preferably in a range from 20 000 to 2 000 000 g/mol, very preferably in a range from 100 000 to 1 500 000 g/mol, most preferably in a range from 150 000 to 1 000 000 g/mol. For this it may be advantageous to conduct the polymerization in the presence of suitable polymerization chain transfer agents such as thiols, halogen compounds and/or alcohols in order to establish the desired average molecular weight.

The statements of the number-average molar mass Mₙ and of the weight-average molar mass M_{w} in this specification are based on the conventional determination by gel permeation chromatography (GPC). The determination is made on 100 μl of sample having undergone clarifying filtration (sample concentration 4 g/l). The eluent used is tetrahydrofuran with 0.1 vol % of trifluoroacetic acid. Measurement is made at 25° C.

The preliminary column used is a column of type PSS-SDV, 5 μm, 10³ Å, 8.0 mm*50 mm (data here and below are in the following order: type, particle size, porosity, internal diameter*length; 1 Å=10⁻¹⁰ m). Separation takes place using a combination of the columns of type PSS-SDV, 5 μm, 10³ Å and also 10⁵ Å and 10⁶ Å each of 8.0 mm*300 mm (columns from Polymer Standards Service; detection by means of Shodex RI71 differential refractometer). The flow rate is 1.0 ml per minute. Calibration in the case of poly(meth)acrylates is made against PMMA standards (polymethyl methacrylate calibration) and otherwise (resins, elastomers) against PS standards (polystyrene calibration).

The poly(meth)acrylate preferably has a polydispersity PD<4 and hence a relatively narrow molecular weight distribution. Compositions based thereon have particularly good shear strength after crosslinking, in spite of a relatively low molecular weight. Moreover, the lower polydispersity enables easier processing from the melt, since the flow velocity is lower as compared with a more broadly distributed poly(meth)acrylate, for largely the same applications properties. Poly(meth)acrylates with a narrow distribution may be prepared advantageously by anionic polymerization or by controlled radical polymerization methods, the latter being particularly suitable. Via N-oxyls as well it is possible to prepare such poly(meth)acrylates. Furthermore, in an advantageous way, atom transfer radical polymerization (ATRP) may be used for the synthesis of narrow-distribution poly(meth)acrylates, in which case the initiator used preferably comprises monofunctional or difunctional, secondary or tertiary halides and, for the abstraction of the halides, complexes of Cu, Ni, Fe, Pd, Pt, Ru, Os, Rh, Co, Ir, Ag or Au. RAFT polymerization is suitable as well.

The poly(meth)acrylates are crosslinked preferably by linking reactions—more particularly in the sense of addition or substitution reactions—of functional groups present therein, with thermal crosslinkers. It is possible to use all thermal crosslinkers which
both ensure sufficiently long processing life, so that there is no gelling during the processing operation, more particularly the extrusion operation,
and lead to rapid postcrosslinking of the polymer to the desired degree of crosslinking at temperatures lower than the processing temperature, more particularly at room temperature. Preference is given to using thermal crosslinkers at 0.1 to 5 wt %, more particularly at 0.2 to 1 wt %, based on the total amount of the polymer to be crosslinked.

Also possible is crosslinking via complexing agents, also referred to as chelates. An example of a preferred complexing agent is aluminum acetyl acetonate.

The poly(meth)acrylates are crosslinked preferably by means of epoxide(s) or by means of one or more substances containing epoxide groups. The substances containing epoxide groups are more particularly polyfunctional epoxides, in other words those having at least two epoxide groups; accordingly, there is overall an indirect linking of those building blocks of the poly(meth)acrylates that carry the functional groups. The substances containing epoxide groups may comprise both aromatic and aliphatic compounds.

Preferred epoxide crosslinkers are, for example, cycloaliphatic epoxides such as 3,4-epoxycyclohexylmethyl 3,4-epoxycyclohexanecarboxylate (UVACure1500).

The poly(meth)acrylates are crosslinked more preferably by means of a crosslinker-accelerator system (“crosslinking system”) in order to obtain better control over the processing life, the crosslinking kinetics and the degree of crosslinking. The crosslinker-accelerator system preferably comprises at least one substance containing epoxide groups, as crosslinker, and as accelerator at least one substance which at a temperature below the melting temperature of the polymer to be crosslinked has an accelerating effect on crosslinking reactions by means of compounds containing epoxide groups.

Accelerators used are with particular preference amines.

In a further embodiment III of the polymer foam layer, the polymer foam layer, more particularly the matrix material of the polymer foam layer, comprises at least one vinylaromatic block copolymer. Preferably the polymer foam layer, more particularly the matrix material of the polymer foam layer, comprises at least one vinylaromatic block copolymer which
contains at least one polymer block A, formed predominantly by polymerization of vinylaromatics, and
contains at least one polymer block B, formed predominantly by polymerization of conjugated dienes, where the fraction of 1,2-linked conjugated diene in the B block is less than 30 wt %, preferably less than 20 wt % (determinable by means of ¹H NMR).

In the embodiment III under consideration here, the above-described vinylaromatic block copolymer is present preferably as an elastomer component in the polymer foam. Where the polymer foam comprises a plurality of elastomer components, it is present in the polymer foam preferably at not less than 50 wt %, based on the total weight of all the elastomer components.

The polymer block A of the preferred vinylaromatic block copolymer is formed predominantly by polymerization of vinylaromatics. This means that the block A typically originates from a polymerization in which more than 50 wt % of the monomers used are vinylaromatics. More preferably the polymer block A originates from a polymerization in which exclusively vinylaromatics have been used as monomers.

The polymer block B of the preferred vinylaromatic block copolymer is formed predominantly by polymerization of conjugated dienes. This means that the block B originates from a polymerization in which more than 50 wt % of the monomers used are conjugated dienes. More preferably the polymer block B originates from a polymerization in which exclusively conjugated dienes have been used as monomers.

The fraction of 1,2-linked conjugated diene in the B block of the preferred vinyl aromatic block copolymer is less than 30 wt %, preferably less than 20 wt %. More preferably this fraction is less than 15 wt %, more particularly 8 to 12 wt %. The fraction of 1,2-linked conjugated diene in the B block means the weight fraction of conjugated diene which has been copolymerized by 1,2-addition (in contrast to 1,4-addition), based on the total monomer composition used in the preparation of the polymer block B. The 1,2-addition of conjugated diene leads to a vinylic side group in the polymer block B, whereas the 1,4-addition of conjugated diene leads to a vinylic functionality in the main chain of the polymer block B. The 1,2-addition of conjugated diene therefore means that the monomer is incorporated into the polymer chain either via positions C1 and C2 or via positions C3 and C4 (in the case of isoprene as conjugated diene, for example). In the 1,4-addition of a conjugated diene, conversely, the monomer is incorporated via positions C1 and C4.

The vinylaromatic block copolymer preferably has an A-B, A-B-A, (A-B)ₙ, (A-B)ₙX or (A-B-A)ₙX construction in which
the blocks A independently of one another are a polymer formed by polymerization of at least one vinylaromatic,
the blocks B independently of one another are a polymer formed by polymerization of conjugated dienes having 4 to 18 carbon atoms,
X is the radical of a coupling reagent or initiator, and
n is an integer >2.

With particular preference in embodiment III all the vinylaromatic block copolymers of the polymer foam layer of the invention are block copolymers having an A-B, A-B-A, (A-B)ₙ, (A-B)ₙX or (A-B-A)ₙX construction as set out above. The polymer foam layer may therefore also comprise mixtures of different vinylaromatic block copolymers having a construction as described above.

The blocks B are also referred to as rubberlike blocks or soft blocks, and the blocks A as glasslike blocks or hard blocks. With particular preference at least one vinylaromatic block copolymer of the polymer foam layer has an A-B, A-B-A, (A-B)₂X, (A-B)₃X or (A-B)₄X construction, with A, B and X having the definitions above. With very particular preference all the vinylaromatic block copolymers have an A-B, A-B-A, (A-B)₂X, (A-B)₃X or (A-B)₄X construction, with A, B and X having the definitions above. More particularly in embodiment III the polymer foam layer comprises a mixture of block copolymers having an A-B, A-B-A, (A-B)₂X, (A-B)₃X or (A-B)₄X construction, which more preferably includes at least diblock copolymers A-B and/or triblock copolymers A-B-A and/or (A-B)₂X, more particularly a mixture of diblock copolymers (A-B) and triblock copolymers (A-B-A), composed for example of two kinds of vinylaromatic block copolymers differing in the weight ratio of diblock copolymers (A-B) and triblock copolymers (A-B-A).

The vinylaromatic block copolymers preferably have a diblock copolymer fraction of 0 wt % to 70 wt %, more preferably of 15 wt % to 65 wt %, more particularly of 30 to 60 wt %, very preferably of 40 to 60 wt %, as for example of 51.5 wt % to 55 wt %.

The block copolymers resulting from the A and B blocks may contain identical or different B blocks.

In preferred vinylaromatic block copolymers, more particularly in preferred styrene block copolymers, the fraction of polyvinylaromatics, more particularly of polystyrene, is preferably at least 12 wt %, more preferably at least 18 wt %, very preferably at least 25 wt % and likewise preferably at most 45 wt % and more preferably at most 35 wt %.

In place of the preferred polystyrene blocks it is also possible as vinylaromatics to use polymer blocks based on other aromatic-containing homopolymers and copolymers having glass transition temperatures of more than 75° C. Preferred homopolymer and/or copolymer blocks are those based on C8 to C12 aromatics such as, for example, a-methylstyrene. Identical or different A blocks may be present.

The polymer block A is preferably formed predominantly by a polymerization of styrene and/or α-methylstyrene. The block A may therefore take the form of a homopolymer or a copolymer.

With particular preference the block A is a polystyrene. With very particular preference the vinylaromatic block copolymer has polystyrene end blocks.

The polymer block B is formed preferably predominantly by a polymerization of conjugated dienes selected from the group consisting of butadiene, isoprene, ethylbutadiene, phenylbutadiene, pentadiene, hexadiene, ethylhexadiene, dimethylbutadiene, α-farnesene and β-farnesene, and any desired mixtures of these monomers; it may be present, like the block A, as a homopolymer or as a copolymer. With particular preference the block B is formed predominantly by a polymerization of butadiene and/or isoprene. With very particular preference the block B is a polybutadiene; in comparison to polyisoprene, polybutadiene has an even better aging behavior.

A Blocks are also referred to in the context of this invention as “hard blocks”. B blocks are also called, correspondingly, “soft blocks” or “elastomer blocks”. This reflects the selection of the blocks according to their glass transition temperatures, which for the A blocks is preferably at least 25° C., more particularly at least 50° C., and for B blocks is preferably at most 25° C., more preferably at most −25° C., and more particularly at most −50° C.

In embodiment III the fraction of the entirety of the vinylaromatic block copolymers, more particularly of the styrene block copolymers, in the polymer foam layer is preferably at least 35 wt %, based on the total weight of the polymer foam layer. A fraction of this kind advantageously improves the cohesion of the polymer foam layer.

The maximum fraction of the entirety of vinylaromatic block copolymers, more particularly of styrene block copolymers, in the polymer foam layer is preferably not more than 75 wt %, more particularly not more than 65 wt %, very preferably not more than 55 wt %.

The polymer foam of embodiment III preferably comprises at least one tackifier resin. In principle there may be one or more tackifier resins present. Accordingly the foam is given advantageously pressure-sensitive adhesive properties.

A “tackifier resin”, is understood in accordance with the general understanding of the skilled person to be a low molecular mass, oligomeric or polymeric resin which increases the adhesion (the tack, the intrinsic stickiness) of the pressure-sensitive adhesive by comparison with the otherwise identical pressure-sensitive adhesive but containing no tackifier resin.

The tackifier resin preferably has a DACP (diacetone alcohol cloud point) of >0° C., more preferably of >10° C., more particularly of >30° C., and a softening temperature (Ring & Ball) of >70° C., preferably of 100° C.

With particular preference the respective tackifier resin has a DACP of not more than 45° C., if there are no isoprene blocks in the elastomer phase, or of not more than 60° C., if there are isoprene blocks in the elastomer phase. With particular preference the softening temperature of the respective tackifier resin is not more than 150° C.

The tackifier resin is preferably a hydrocarbon resin; more particularly it is selected from the group consisting of hydrogenated and unhydrogenated polymers of dicyclopentadiene, unhydrogenated, partially, selectively or completely hydrogenated hydrocarbon resins based on C5, C5/C9 or C9 monomer streams, and polyterpene resins based on α-pinene and/or β-pinene and/or δ-limonene. These tackifier resins may be used either alone or in a mixture. In principle it is possible to use resins which are solid and resins which are liquid at room temperature. Tackifier resins, hydrogenated or unhydrogenated, which also contain oxygen may be present optionally at up to a maximum fraction of 25 wt %, based on the total mass of the tackifier resins contained in the polymer foam, in the polymer foam of embodiment III, examples of these being rosins and/or rosin ester resins and/or terpene-phenol resins.

With particular preference the tackifier resin is an unhydrogenated hydrocarbon resin, more particularly based on α-pinene. These resins provide the polymer foam not only with high cohesion but also, advantageously, with very high adhesion, including in particular at high temperatures.

The polymer foam with embodiment III preferably contains 20 to 60 wt %, more preferably 30 to 50 wt %, of at least one tackifier resin, based in each case on the total weight of the polymer foam.

Foaming

In principle foams may be produced in two ways: firstly, by the action of a propellant gas, whether added as such or resulting from a chemical reaction, and secondly through the incorporation of hollow spheres into the matrix of material. Foams produced in the latter way are referred to as syntactic foams.

Physical propellants are any naturally occurring atmospheric materials which are in gas form at the temperature and pressure at which the foam emerges from the nozzle. Physical propellants may be introduced into the matrix material, i.e., injected, in the form of a gas, a supercritical fluid or a liquid. The choice of physical propellant used is dependent on the desired properties of the resulting foams. Other factors to be borne in mind when selecting a propellant are its toxicity, the vapor pressure profile, the ease of handling, and the solubility in relation to the polymeric materials used. Flammable propellants such as pentane, butane and other organic materials such as hydrofluorocarbons and hydrochlorofluorocarbons may be used; preference, however, is given to incombustible, nontoxic propellants which do not degrade ozone, the reasons being that they are easier to use, are subject to fewer concerns regarding their effects on the environment, etc. Preferred physical propellants are carbon dioxide, nitrogen, SF6, nitrogen oxides, perfluorinated liquids such as C2F6, noble gases such as helium, argon and xenon, air (typically a mixture of nitrogen and oxygen), and mixtures of these materials.

Another, alternative possibility is to use chemical propellants for the foaming. Suitable chemical propellants encompass mixtures of sodium bicarbonate and citric acid, dinitrosopentamethylenetetramine, p-toluenesulfonyl hydrazide, 4-4′-oxybis(benzenesulfonyl hydrazide, azodicarbonamide (1,1′-azobisformamide), p-toluenesulfonyl semicarbazide, 5-phenyltetrazole, 5-phenyltetrazole analogs, diisopropyl hydrazodicarboxylate, 5-phenyl-3,6-dihydro-1,3,4-oxadiazin-2-one, and sodium borohydride.

The polymer foam layer preferably comprises microballoons; in this case it is foamed at least using microballoons. Where it is foamed only by means of microballoons, it is a syntactic foam.

“Microballoons” are understood to refer to hollow microspheres which are elastic and hence expandible in their ground state, with a thermoplastic polymer shell. These spheres are filled with low-boiling liquids or liquefied gas. Shell material used includes, in particular, polyacrylonitrile, PVDC, PVC or polyacrylates. Customary low-boiling liquid comprises, in particular, hydrocarbons of the lower alkanes, as for example isobutane or isopentane, which are enclosed under pressure in the polymer shell, in the form of liquefied gas.

Action on the microballoons, particularly by exposure to heat, causes the outer polymer shell to soften. At the same time, the liquid propellant gas within the shell is converted to its gaseous state. The microballoons in this case extend out irreversibly and undergo three-dimensional expansion. Expansion is at an end when the internal and external pressures are balanced. Since the polymeric shell is conserved, the result is a closed-cell foam.

A multiplicity of types of microballoon are available commercially, and differ essentially in terms of their size (6 to 45 μm diameter in the unexpanded state) and in the starting temperatures that they require for expansion (75 to 220° C.). Unexpanded microballoon types are also available in the form of aqueous dispersion having a solids fraction or microballoon fraction of around 40 to 45 wt %, and additionally in the form of polymer-bound microballoons (masterbatches) as well, for example in ethylene-vinyl acetate with a microballoon concentration of around 65 wt %. Not only the microballoon dispersions but also the masterbatches, like the unexpanded microballoons, are suitable as such for producing the polymer foam layer.

The polymer foam layer may also be generated with what are called preexpanded microballoons. In the case of this group the expansion takes place prior to incorporation into the polymer matrix.

The polymer foams may also be generated using foamed particles; that is, with expanded or expandible beads of, in particular polystyrene, polypropylene, thermoplastic polyurethane or cellulose acetate. Accordingly, particles of plastics which per se have already undergone foaming are incorporated into the polymer matrix, and produced the reduction in density. The particles may also be put unfoamed into the polymer matrix and only then be foamed. Furthermore, the polymer foam may also consist of optionally preexpanded beads joined to one another thermally, more particularly fused together, so that in this case there is no other surrounding matrix.

The polymer foam may comprise aging inhibitors, examples being primary antioxidants such as sterically hindered phenols, secondary antioxidants such as phosphites orthioethers and/or C-radical scavengers. Additionally present, furthermore, may be, for example, light stabilizers such as UV absorbers or sterically hindered amines; antiozonants; metal deactivators and/or processing assistants.

The polymer foam may additionally comprise filler such as, for example, silicone dioxide, glass (ground or in the form of beads), aluminum oxides, zinc oxides, calcium carbonates, titanium dioxides, carbon blacks, etc., and also pigments, dyes and/or optical brighteners.

Outer Pressure-Sensitive Adhesive Layer

A pressure-sensitive adhesive (PSA) or pressure-sensitive adhesive composition is understood in the invention, and customarily in the general usage, as a material which at least at room temperature is permanently tacky and also adhesive. A characteristic of a PSA is that it can be applied by pressure to a substrate and remains adhering there, with no further definition of the pressure to be applied or the period of exposure to this pressure. In general, though in principle dependent on the precise nature of the PSA and also on the substrate, the temperature and the atmospheric humidity, the influence of a minimal pressure of short duration, which does not go beyond gentle contact for a brief moment, is enough to achieve the adhesion effect, while in other cases a longer-term period of exposure to a higher pressure may also be necessary.

PSAs have particular, characteristic viscoelastic properties which result in the permanent tack and adhesiveness. The feature of these adhesives is that when they are mechanically deformed, there are processes of viscous flow and there is also development of elastic forces of recovery. The two processes have a certain relationship to one another in terms of their respective proportion, in dependence not only on the precise composition, the structure and the degree of crosslinking of the PSA, but also on the rate and duration of the deformation, and on the temperature.

The proportional viscous flow is necessary for the achievement of adhesion. Only the viscous components, frequently brought about by macromolecules with relatively high mobility, permit effective wetting and effective flow onto the substrate where bonding is to take place. A high viscous flow component results in high tack (also referred to as surface stickiness) and hence often also in high adhesion. Highly crosslinked systems, crystalline polymers, or polymers with glasslike solidification lack flowable components and are in general devoid of tack or possess only little tack at least.

The proportion of elastic forces of recovery are necessary for the achievement of cohesion. They are brought about, for example, by very long-chain macromolecules with a high degree of coiling, and also by physically or chemically crosslinked macromolecules, and they allow the transmission of the forces that act on an adhesive bond. As a result of these forces of recovery, an adhesive bond is able to withstand a long-term load acting on it, in the form of a sustained shearing load, for example, to a sufficient degree over a relatively long time period.

For more precise description and quantification of the extent of elastic and viscous components, and also of the relationship between the components, the variables of storage modulus (G′) and loss modulus (G″) are employed, and can be determined by means of dynamic mechanical analysis (DMA). G is a measure of the elastic component, G″ a measure of the viscous component, of a substance. Both variables are dependent on the deformation frequency and the temperature.

The variables can be determined using a rheometer. In that case, for example, the material under investigation is exposed in a plate/plate arrangement to a sinusoidally oscillating shear stress. In the case of instruments operating with shear stress control, the deformation is measured as a function of time, and the time offset of this deformation is measured relative to the introduction of the shear stress. This time offset is referred to as the phase angle 5.

The storage modulus G′ is defined as follows: G′=(τ/γ)·cos(b) (τ=shear stress, γ=deformation, δ=phase angle=phase shift between shear stress vector and deformation vector). The definition of the loss modulus G″ is as follows: G″=(τ/γ)·sin(b) (τ=shear stress, γ=deformation, δ=phase angle=phase shift between shear stress vector and deformation vector).

A composition is considered in particular to be a PSA, and is defined in particular as such for the purposes of the invention, when at 23° C., in the deformation frequency range from 10° to 10¹ rad/sec, both G′ and G″ are situated at least partly in the range from 10³ to 10⁷ Pa. “Partly” means that at least a section of the G′ curve lies within the window subtended by the deformation frequency range from 10⁰ inclusive up to 10¹ inclusive rad/sec (abscissa) and by the G′ value range from 10³ inclusive to 10⁷ inclusive Pa (ordinate), and when at least a section of the G″ curve is likewise situated within the corresponding window.

The outer pressure-sensitive adhesive layer comprises one or more poly(meth)acylates preferably to an extent of at least 50 wt %, more preferably at least 70 wt %, very preferably at least 90 wt %, more particularly at least 95 wt %, as for example at least 97 wt %, based in each case on the total weight of the pressure-sensitive adhesive layer.

The outer pressure-sensitive adhesive layer comprises one or more poly(meth)acylates with particular preference to an extent of at least 50 wt %, more preferably at least 70 wt %, very preferably at least 90 wt %, more particularly at least 95 wt %, as for example at least 97 wt %, based in each case on the total weight of the pressure-sensitive adhesive layer, these poly(meth)acrylates originating from the following monomer composition:
Mon1) at least one acrylic ester and/or methacrylic esters of the formula (2)

CH₂═C(R^{III})(COOR^{IV}) (2),
in which R^{III} is H or CH₃ and R^{IV} is an alkyl radical having 4 to 12 carbon atoms;
Mon2) at least one olefinically unsaturated monomer having at least one functional group selected from the group consisting of carboxylic acid groups, sulfonic acid groups, phosphonic acid groups, hydroxyl groups, acid anhydride groups, epoxide groups and amino groups;
Mon3) optionally at least one acrylic ester and/or methacrylic ester of the formula (3)

CH₂═C(R^{V})(COOR^{VI}) (3),
in which R^{V} is H or CH₃ and Rvi is an alkyl radical having 1 to 3 carbon atoms.

It is possible independently of one another for in each case one or more monomers Mon1, Mon2 and Mon3 to be present in the monomer composition.

Monomers Mon1 here are present in the monomer composition preferably at not less than 70 wt %, more preferably at not less than 80 wt %, based in each case on the total weight of the said composition.

Monomers Mon2 are present in the monomer composition preferably at 1 to 15 wt %, based on the total weight of said composition.

Monomers Mon3, if present at all, are present in the monomer composition preferably at 5 to 15 wt %, based on the total weight of said composition.

The monomers Mon1 preferably comprise at least one branched monomer. With particular preference the monomers a) are selected from the group consisting of n-butyl acrylate, n-butyl methacrylate, n-pentyl acrylate, n-pentyl methacrylate, n-amyl acrylate, n-hexyl acrylate, n-hexyl methacrylate, n-heptyl acrylate, n-octyl acrylate, n-octyl methacrylate, n-nonyl acrylate, isobutyl acrylate, isooctyl acrylate, isooctyl methacrylate, 2-ethylhexyl acrylate and 2-ethylhexyl methacrylate, 2-propylheptyl acrylate and isobornyl acrylate. With particular preference, the monomers Mon1 are selected from n-butyl acrylate, 2-ethylhexyl acrylate and isobornyl acrylate.

The monomers Mon2 are preferably selected from the group consisting of acrylic acid, methacrylic acid, itaconic acid, maleic acid, fumaric acid, crotonic acid, aconitic acid, dimethylacrylic acid, β-acryloyloxypropionoic acid, trichloroacrylic acid, vinylacetic acid, vinylphosphonic acid, maleic anhydride, hydroxyethyl acrylate, hydroxypropyl acrylate, hydroxyethyl methacrylate, hydroxypropyl methacrylate, 6-hydroxyhexyl methacrylate, allyl alcohol, glycidyl acrylate and glycidyl methacrylate. Present with particular preference as monomer Mon2 is acrylic acid.

Present preferably as monomer Mon3 if present at all, is methyl acrylate.

With particular preference the poly(meth)acrylate of the outer pressure-sensitive adhesive layer originates from a monomer composition comprising

70 to 95 wt % of 2-ethylhexyl acrylate, n-butyl acrylate and/or isobornyl acrylate; more particularly n-butyl acrylate and 2-ethylhexyl acrylate;

1 to 15 wt % of acrylic acid; and

0 to 15 wt % of methyl acrylate.

More particularly the poly(meth)acrylate of the outer pressure-sensitive adhesive layer originates from a monomer composition comprising

70 to 95 wt % of 2-ethylhexyl acrylate, n-butyl acrylate and/or isobornyl acrylate; more particularly n-butyl acrylate and 2-ethylhexyl acrylate;

1 to 15 wt % of acrylic acid; and

0 to 15 wt % of methyl acrylate.

The poly(meth)acrylates of the outer pressure-sensitive adhesive layer are preferably crosslinked thermally, more particularly covalently and/or coordinatively. Preferred covalent crosslinkers are epoxy compounds; preferred coordinative crosslinkers are aluminum chelates.

The weight-average molecular weight M_{w} of the poly(meth)acrylates of the outer pressure-sensitive adhesive layer is preferably 20 000 to 2 000 000 g/mol, more preferably 100 000 to 1 500 000 g/mol, more particularly 200 000 to 1 200 000 g/mol. The figures for the average molecular weight M_{w} in this specification are based on the determination by gel permeation chromatography (see experimental section).

Outer Thermoplastic Film

“Outer thermoplastic film” means that the thermoplastic film faces outward and so finishes the construction of the adhesive tape on the film side.

Adhesive properties are present in the thermoplastic film either not at all or only to a very small degree, and so in any conceivable construction of the adhesive tape of the invention comprising an outer thermoplastic film, the film finishes the side having the weaker peel adhesion. If, therefore, the adhesive tape does comprise an outer thermoplastic film, it has a lower peel adhesion on its side equipped with the outer thermoplastic film than on the opposite side, or it has no peel adhesion on its side equipped with the outer thermoplastic film.

The thermoplastic film preferably comprises at least one polymer selected from the group consisting of thermoplastic polyolefins (TPE-E or TPO), more particularly thermoplastic polyolefin elastomers (POE); and thermoplastic polyolefin plastomers (POP); thermoplastic polystyrene elastomers (TPE-S or TPS), more particularly styrene block copolymers (SBC); thermoplastic polyurethane elastomers (TPE-U or TPU); thermoplastic polyester elastomers and copolyesters (TPE-E or TPC); thermoplastic copolyamides (TPE-A or TPA); and thermoplastic vulcanizates and also crosslinked thermoplastic polyolefin elastomers (TPE-V or TPV).

More particularly the thermoplastic film consists of at least one, with particular preference one, polymer selected from the group consisting of thermoplastic polyolefins (TPE-E or TPO), more particularly thermoplastic polyolefin elastomers (POE); and thermoplastic polyolefin plastomers (POP); thermoplastic polystyrene elastomers (TPE-S or TPS), more particularly styrene block copolymers (SBC); thermoplastic polyurethane elastomers (TPE-U or TPU); thermoplastic polyester elastomers and copolyesters (TPE-E or TPC); thermoplastic copolyamides (TPE-A or TPA); and thermoplastic vulcanizates and also crosslinked thermoplastic polyolefin elastomers (TPE-V or TPV).

Adhesive Tape Construction

The construction or the layer sequence of an adhesive tape of the invention encompasses multiple variants. In one embodiment the construction of the adhesive tape of the invention is confined to the polymer foam layer and an outer pressure-sensitive adhesive (PSA) layer. In this case the adhesive tape of the invention therefore consists of
a) a polymer foam layer and
b) an outer PSA layer.

The requisite weaker peel adhesion on the side opposite the outer PSA layer results in this case from the fact that the exposed side of the polymer foam layer has a weaker peel adhesion than the PSA layer. In this embodiment the polymer foam layer corresponds preferably to a polymer foam layer of the embodiment II described there; the polymer foam layer, more particularly the matrix material of the polymer foam layer, thus preferably comprises at least one poly(meth)acrylate. All more detailed configurations described in the context of embodiment II of the polymer foam layer are valid here correspondingly.

In principle the invention also embraces an embodiment in which an outer PSA layer is arranged on both sides of the polymer foam layer in each case. Of course, in line with the core concept of the invention, the two outer PSA layers in this case are not identical and differ in particular in their peel adhesion.

In another embodiment of the invention the adhesive tape of the invention consists of
a) a polymer foam layer and
b) an outer thermoplastic film.

In this embodiment the polymer foam layer corresponds preferably to a polymer foam layer of the embodiment III described there; the polymer foam layer, more particularly the matrix material of the polymer foam layer, therefore preferably comprises at least one vinylaromatic block copolymer. All more detailed configurations described in the context of embodiment III of the polymer foam layer are valid here correspondingly.

The polymer foam layer in this embodiment in particular has sufficient (pressure-sensitive) adhesive tack to enable a sufficiently firm bond between itself and the outer thermoplastic film.

In further embodiment of the invention the adhesive tape consists of
a) a polymer foam layer;
b1) an outer PSA layer on one side of the polymer foam layer; and
b2) an outer thermoplastic film on the side of the polymer foam layer opposite the outer PSA layer.

In this embodiment the polymer foam layer corresponds preferably to a polymer foam layer of the embodiment II described there; the polymer foam layer, more particularly the matrix material of the polymer foam layer, therefore comprises at least one poly(meth)acrylate. All more detailed configurations described in the context of embodiment II of the polymer foam layer are valid here correspondingly.

The polymer foam layer in this embodiment in particular has sufficient (pressure-sensitive) adhesive tack to enable a sufficiently firm bond between itself and the outer thermoplastic film.

In a further embodiment the adhesive tape, in addition to the polymer foam layer, comprises
b1) an outer PSA layer on one side of the polymer foam layer; and
b2) an outer thermoplastic film on the side of the polymer foam layer opposite the outer PSA layer; and
c) a further PSA layer on the side of the polymer foam layer opposite the outer PSA layer.

The further PSA layer in this embodiment is therefore located between the polymer foam layer and the outer thermoplastic film; with preference it joins the polymer foam layer to the outer thermoplastic film.

The further PSA layer is subject to the observations made regarding the outer PSA layer. Preferably the further PSA layer and the outer PSA layer are identical in terms of their composition; more particularly they are identical not only in terms of their composition but also in terms of their layer thickness.

In this embodiment as well the polymer foam layer corresponds preferably to a polymer foam layer of the embodiment II described there; the polymer foam layer, more particularly the matrix material of the polymer foam layer, therefore preferably comprises at least one poly(meth)acrylate. All more detailed configurations described in the context of embodiment II of the polymer foam layer are valid here correspondingly.

Use

A further subject of the invention is the use of an adhesive tape of the invention for sealing a join between two components. Advantageously here the adhesive tape of the invention permits rapid bonding and hence the rapid production of the seal without slipping and without the need for curing. It is possible to provide watertight seals which have little susceptibility to corrosion. Moreover, it is easier to disassemble the join, because the component joined with the weaker-bonding side is more easily removed.

The join between the two components has preferably been brought about in a manner other than by adhesive bonding; with particular preference the join between the components is a join effectuated mechanically, by screw connection, for example.

The two components are in principle arbitrary; the term “components” is understood in a very far-reaching sense. The two components are preferably the housing and the cover of a vehicle battery; with particular preference, when a join of this kind is sealed, the weaker-bonding side of the adhesive tape faces the cover. The components, additionally, may also belong to an electronic device, such as to a smartphone or the like, for example.

Likewise preferably in the context of its use in accordance with the invention the adhesive tape of the invention is taken off from a cross-wound spool; in particular, this step is automated.

### EXAMPLES

Test Methods

Gel permeation chromatography for determining the molecular weight: The molecular weight data in this specification are based on a determination by gel permeation chromatography. The determination is made on 100 μl of a sample having undergone clarifying filtration (sample concentration 4 g/l). The eluent used is tetrahydrofuran with 0.1 vol % of trifluoracetic acid. Measurement takes place at 25° C. The preliminary column used is a column of type PSS-SDV, 5μ, 10 Å, ID 8.0 mm-50 mm. Separation takes place using the columns of type PSS-SDV, 5μ, 10³A and also 10⁵ Å and 10⁶ Å each of ID 8.0 mm×300 mm (columns from Polymer Standards Service; detection using Shodex R171 differential refractometer). The flow rate is 1.0 ml per minute. Calibration takes place against PMMA standards (polymethyl methacrylate calibration).

Water Permeability:

Strips 5 mm wide were cut from the adhesive tape under investigation and were adhered to a square metal plate (external dimensions 80 mm×80 mm×5 mm). The strips were arranged so as to form a closed square contour. The ends of a strip were each joined flush with the side face of the next strip end.

In the inside of the square, a paste (KMnO₄) was then applied which undergoes a marked color change to violet on contact with water. An identical metal plate was then placed onto the construction and screw-connected. The screws were located outside the square of adhesive tape strips. The distance between the metal plates were set at exactly 2 mm by means of 2 shims each 1 mm thick. This construction ensured that the water-reactive paste is in a closed space within the adhesive tape strips. Penetration of water would be apparent from a color change and would imply a lack of imperviousness of the adhesive tape.

The entire sample was then placed into a water bath which was subsequently placed into an autoclave. Initially a small superatmospheric pressure of 0.3 bar was applied; in a second test, a superatmospheric pressure of 3 bar then simulated a water column of 30 m. After 30-minutes storage under water in the autoclave, the superatmospheric pressure was let down, the assembly was withdrawn, and the sample was studied for color change of the KMnO₄. A change in color indicates water permeability of the adhesive tape; no change in color indicates imperviousness to water (result “water-permeable yes/no”).

Redetachability of the bonded substrate (simulating the redetachment of a bonded battery cover; reopenability):

The adhesive tape was applied once around by the more strongly adhering side to an aluminum plate (450×250 mm, 2.5 mm thickness) at a distance of 30 mm from the plate edge. A further aluminum plate (450×250 mm, 1 mm thickness) with identical dimensions was applied to the free side (from above). Shims 2 mm thick were inserted into the joints on each side, after which the assembly was compressed in a screw clamp. The aluminum plates were thereafter screwed to one another, utilizing holes present for that purpose in the corners of the plates.

The resultant assembly was stored for 10 days in a conditioned chamber at 40° C. and 100% relative humidity. Following removal it was reconditioned for 24 h at 23° C. and 50% relative humidity.

The screws and shims were then removed, and on one of the shorter sides a tensioning strap was inserted into the joint, this strap being connected to a testing machine (Zwick). The upper (1 mm) plate was pulled off at an angle of 90° and a velocity of 300 mm/min, and a measurement was made of the maximum force required for this purpose. Table 1 reports the average value from three measurements.

Adhesive Tapes Used

A—Tesa® 61102 (closed-cell EPDM rubber foam, coated on one side with an acrylate adhesive, to total thickness 3200 μm; tesa)

B—Tesa® ACXU^{plus} 70730 High Resistance (double-sided acrylate foam tape, coated on both sides with acrylate PSA, total thickness 2900 μm; tesa), laminated on one side with a thermoplastic polyurethane film (Platilon® U04/PE, 30 μm; Bayer)

C—Tesa® ACXP's 70730 High Resistance, with the acrylate PSA applied only one side, the acrylate foam therefore lying exposed on one side (see B, total thickness 2850 μm; tesa)

D—Tesa® 92111 HiP—High initial Performance, bonded to itself 3×, total thickness 3300 μm; tesa); laminated on one side with a thermoplastic polyurethane film (Platilon® U04/PE, 30 μm; Bayer)

E—Tesa® ACX^{plus} 70730 High Resistance (double-sided acrylate foam tape, coated on both sides with acrylate PSA, total thickness 2900 μm; tesa); comparative example

TABLE 1
test results

| | Water | Water | |
|---|---|---|---|
| Adhesive | permeability at | permeability at | |
| tape | 0.3 bar | 3 bar | Redetachability |
| A | No | Yes | |
| B | No | No | Measurement not required; |
| | | | the bond could be parted |
| | | | very easily by hand |
| C | No | No | 148 N |
| D | No | No | Measurement not required; |
| | | | the bond could be parted |
| | | | very easily by hand |
| E (comp.) | No | No | >500 N |

comp. = comparative example

1. An adhesive tape with differing peel adhesion on both main sides, comprising
a) a polymer foam layer; and
b) an outer pressure-sensitive adhesive layer and/or an outer thermoplastic film on respectively one side of the polymer foam layer;
wherein
if the adhesive tape comprises an outer pressure-sensitive adhesive layer, it has a higher peel adhesion on its side equipped with the outer pressure-sensitive adhesive layer than on its opposite side;
and/or
if the adhesive tape comprises an outer thermoplastic film, it has a lower peel adhesion on its side equipped with the outer thermoplastic film than on its opposite side.

2. The adhesive tape as claimed in claim 1, wherein to an extent of at least 35 wt %, based on a total weight of the polymer foam layer, the polymer foam layer comprises one or more polymers selected from the group consisting of polyolefins; polyurethanes; polyvinyl chloride (PVC); blends of PVC and nitrile rubber; terpolymers of ethylene, propylene and a nonconjugated diene (EPDM); copolymers of ethylene and an ethylene substituted by a polar group; blends of polyethylene and a polymer of an ethylene substituted by a polar group; poly(meth)acrylates; blends of poly(meth)acrylate and synthetic rubber, and also mixtures of two or more of said polymers.

3. The adhesive tape as claimed in claim 1, wherein the polymer foam layer comprises at least one poly(meth)acrylate.

4. The adhesive tape as claimed in claim 1, wherein the polymer foam layer comprises microballoons.

5. The adhesive tape as claimed inclaim 1, wherein the adhesive tape consists of:
a) a polymer foam layer; and
b) an outer pressure-sensitive layer on one side of the polymer foam layer.

6. The adhesive tape as claimed in claim 1, wherein the adhesive tape consists of:
a) a polymer foam layer; and
b) an outer thermoplastic film on one side of the polymer foam layer.

7. The adhesive tape as claimed in claim 1, wherein the adhesive tape consists of:
a) a polymer foam layer;
b) an outer pressure-sensitive adhesive layer on one side of the polymer foam layer; and
c) an outer thermoplastic film on the other side of the polymer foam layer.

8. A method comprising sealing a joint between two components with an adhesive tape, wherein the adhesive tape is an adhesive tape as claimed in claim 1.

9. The method as claimed in claim 8, wherein the joint between the components is a mechanically effectuated joint.
